(19) United States
(12) Patent Application Publication
(10) Pub. No.: US 2016/0117686 A1
(43) Pub. Date: Apr. 28, 2016

(54) SYSTEM AND METHOD FOR GENERATING A RANDOM NUMBER AND/OR MARKER SENTENCE USING SPOKEN SENTENCE

(71) Applicant: Raghavachari SRIVATCHAN, Chennai (IN)

(72) Inventor: Raghavachari SRIVATCHAN, Chennai (IN)

(21) Appl. No.: 14/895,492

(22) PCT Filed: Jul. 8, 2014
(86) PCT No.: PCT/IN2014/000455

§ 371 Date: Dec. 3, 2015

(30) Foreign Application Priority Data
Jul. 10, 2013 (IN) 3086/CHE/2013

(51) Int. Cl. G06Q 30/00; G10L 15/08; G10L 25/54; G06F 7/58

(52) U.S. Cl. CPC G06Q 30/0185; G06F 7/58; G10L 15/08; G10L 25/54; G10L 2015/088

(57) ABSTRACT

A system and method for generating a random number and/or marker sentence using spoken sentence is provided. The system includes a master table which stores a unique value for each characters/word of the spoken sentence, a master rule and a configuration database. The configuration database stores a list of manufacturer and a list of products associated to the each manufacturer and the list of rules for each of the manufacturers and/or each of the products. The configuration database also includes a book set which stores a list of cue-words. The system generates the random number based on the spoken sentence using mater table and master rule. The system generates a marker by identifying and appending the cue-word to the spoken sentence based on set of rules stored in the configuration database.

### FIELD OF THE INVENTION

The present invention generally relates to a system and method for generating random number using spoken sentence in any and all languages used by humans and more particularly, but not exclusively, to the system and method for generating and processing a marker sentence for a unit level product authentication using random number.

### BACKGROUND OF THE INVENTION

Several companies invented different systems and methods for identifying genuine products and brands and authenticating them. Most of the methods involve the use of special marking inks, holograms, RFID, smart tags etc. These can be easily duplicated and are cost prohibitive. Besides they require special equipment and expertise to identify and conclude the authenticity. Most importantly significant number of them do not offer real time and immediate validation ability and are not easily verifiable by ordinary means.

Further marking can be overt or covert. Sometimes markers used tend to be jumbled to avoid pattern deduction. But this jumbling makes it difficult to repeat and tedious. While there are several inventions requiring maintenance of huge and growing databases this invention operates with an embedded algorithm that is dynamically derived and is unique to each marking. Some of the known prior art are

Kezzler: US patent number 20110107100 given to MagnarLokenD.y. and assigned to Kezzler AS Oslo, NO

Sproxil: 20110251969 & 20110247960 given to AshifiGogo & Alden Zecha and exploited by Sproxillnc, Cambridge, Mass. US.

Both these and few others are systems that allow a consumer to directly verify if the pack that he/she is getting is genuine. All of them use a jumble of alphabets and numbers and are difficult and error prone for inputting to various verification systems. All of the prior art require a large database to be maintained. In contrast current invention uses only spoken sentences or parts there of that are intelligent and require no database for effective authentication.

Accordingly there is a need in the art to provide a solution to one or more of above said problems. The present invention solves one or more of these problems in a unique and economical manner.

### SUMMARY OF THE INVENTION

It is a feature of the present invention to provide a system which substantially overcomes the one or more of the above mentioned disadvantages.

The main object of the present embodiment is to present a system for generating a random number based on a spoken sentence. Further, the system for generating a marker sentence for avoiding the product counterfeiting.

In one aspect a method for generating a marker which is used for product verification of one or more products manufactured by one or more manufacturers is provided. The method includes (i) obtaining a sentence from a data source or from an user, (ii) processing the sentence based on a first set of rules to remove unwanted words in the sentence and obtain a qualified sentence, (iii) generating a random number from the qualified sentence, wherein the random number is generated using master tables and a second set of rules based on a predefined iterations, (iv) identifying a cue word from a book set/database based on the random number, wherein the random number is processed based on a third set of rules to obtain the cue word from the book set, (v) appending the cue word to the qualified sentence as per a fourth set of rules to obtain the marker, wherein the marker is attached to the plurality of products. The first set of rules, the second set of rules, the third set of rules, the fourth set of rules and the predefined iterations are defined in a configuration database for each of the one or more manufacturers and/or the one or more products. The master table includes one or more tables and each table stores one or more characters and its corresponding values. The book set comprises ‘n’ rows and ‘m’ columns and storing a plurality of cue words. The data source receives one or more sentences from variety of sources such as databases or on line. The sentence can be in any commonly spoken or written language and may or may not include specialized languages such as programming languages, current or out of vogue.

In another aspect a method for verifying a marker which is used for product verification of one or more products manufactured by one or more manufacturer is provided. The method includes (a) receiving a verification message from a user, wherein the verification message comprises an identifier and a marker, (b) identifying a first cue word from the marker based on the identifier, (c) removing the first cue word to obtain a qualified sentence, (d) storing the first cue word, (e) generating a random number from the qualified sentence, wherein the random number is generated using master tables and a second set of rules, and the master tables and the second set of rules applied to the qualified sentence for a predefined iterations, (f) identifying a second cue word from a book set based on the random number wherein the random number is processed based on a third set of rules to obtain the cue word from the book set, (f) comparing the second cue word and the first cue word, (g) communicating to the user that the product is genuine product when the first cue word and the second cue word are same and (h) communicating to the user that the product is counterfeit product when the first cue word and the second cue word are not same. The verification message as a short message service (SMS) message or an electronic mail and wherein the identifier comprises a product code or a product name.

In yet another aspect, a method for generating a text based random number is provided. The method includes (i) obtaining a sentence from a data source, (ii)generating a number from the qualified sentence, wherein the number is generated using master tables and a second set of rules, and the master tables and the second set of rules applied to the qualified sentence for a predefined iterations. The number being obtained from vast source of sentences from multitude of languages and obtained by using tables of values and iterated using rules generated from and out of such sentence, qualify to be a random number

### BRIEF DESCRIPTION OF THE ACCOMPANYING DRAWINGS

The advantages and features of the invention will become more clearly apparent from the following description which refers to the accompanying drawings given as non-restrictive examples only and in which:

FIG. 1 illustrates a system for generating random number and/or product authentication in accordance to a preferred embodiment herein;

FIG. 2 illustrates a process of sentence selection and sentence processing performed in the sentence selecting module and sentence processing module of the FIG. 1 in accordance to one embodiment herein;

FIG. 3 illustrate a master table of the FIG. 1 in accordance to one embodiment herein;

FIG. 4 illustrate a marker sentence generation in accordance to one embodiment herein;

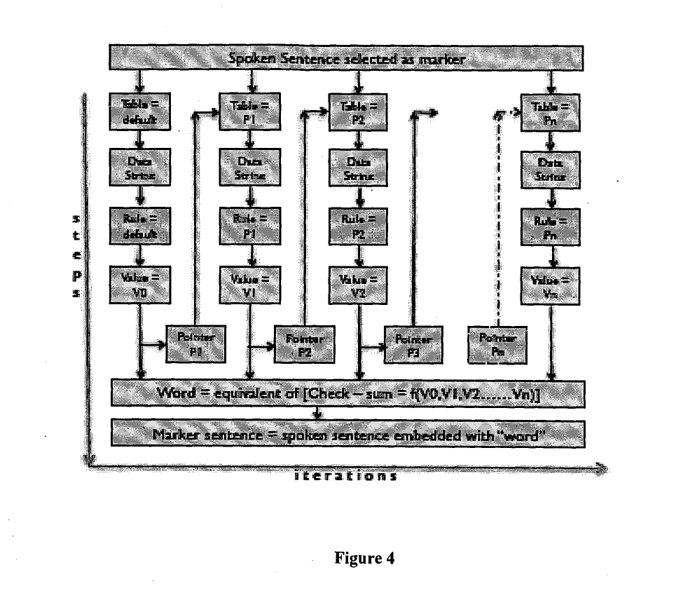

FIG. 5 is a flow diagram which illustrates a method for generating marker sentence based on the spoken sentence in accordance to one embodiment herein; and

FIG. 6 is a flow diagram which illustrates a method for generating marker sentence based on the spoken sentence in accordance to one embodiment herein.

### DETAILED DESCRIPTION OF THE INVENTION

The present invention will be described herein below with reference to the accompanying drawings. A system and method for generating a random number and/or marker sentence for product authentication from the spoken sentence is described.

The following description is of exemplary embodiment of the invention only, and is not limit the scope, applicability or configuration of the invention. Rather, the following description is intended to provide a convenient illustration for implementing various embodiments of the invention. As will become apparent, various changes may be made in the function and arrangement of the structural/operational features described in these embodiments without departing from the scope of the invention as set forth herein. It should be appreciated that the description herein may be adapted to be employed with alternatively configured devices having different shaped, components, and the like and still fall within the scope of the present invention. Thus the detailed description herein is presented for purposes of illustration only and not of limitation.

The present invention relates to a system and method for generating a random number and/or providing unit level product authentication, product serialization and brand verification system, methods and solution by using ordinary spoken sentences or group of words, names etc., be they convey any meaning or not, right or not, grammatical or not, functional or not, complete or not in any language in use in the world with its alphabets amenable for keying in with a keyboard and computer recognizable, as markers independent of current methods and systems in use, by the use of set of tables, primary functions, complex functions, rules and relationships interactively and iteratively.

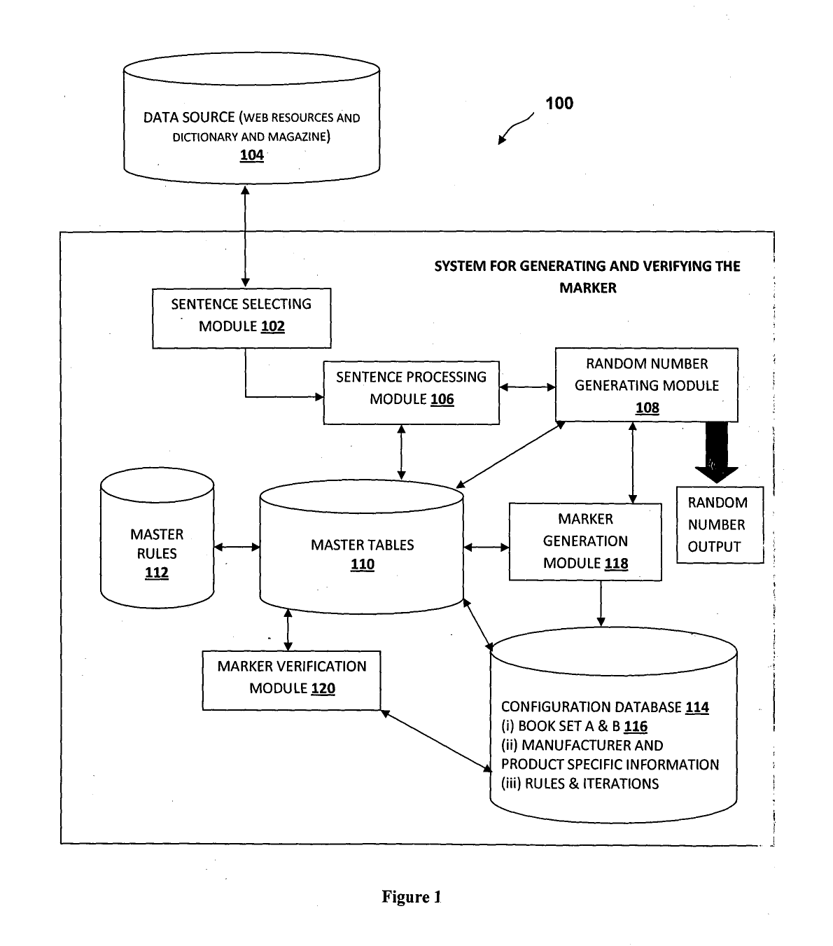

FIG. 1 illustrates a system 100 for generating random number and/or product authentication in accordance to a preferred embodiment herein. The system includes a sentence selecting module 102 which is interfaced with a data source 104 to obtain a sentence, a sentence processing module 106, a random number generating module 108, a master tables 110, a master rules 112, a configuration database 114, a book set 116, a marker generation module 118, and a marker verification module 120. The configuration database 114 stores the product information, manufacturer information and the set of rules and one or more criteria for each of the product and/or manufacture. The sentence obtained from the sentence selecting module 102 is processed by the sentence processing module 106 to obtain the qualified sentence. The sentence processing module is processes the sentence based on the one or more criteria stored in the configuration database 114. The one or more criteria includes at least one of but not limited to removal of article, specified words, stop words etc. In one embodiment, the data processing module 106 do not process the sentence obtained from the sentence selecting module 102. For example, the system 100 used for generating the random numbers then the data processing module 106 do not process the sentence. In another example, the configuration database 114 also specifies the “do not process” criteria for some product and/or manufacturer. The random number generating module 108 obtains the qualified sentence from the data processing module 106 and generates the random number/random number based on the one or more rules stored in the configuration database. The marker generation module 118 processes the random number and appends the cue word obtained from the book set 116 based on the one or more rules stored in the configuration database 114. The marker verification module 120 receives the verification message from the user and process the verification message to identify whether the product associated to the verification message is “genuine” or “suspect”.

The master table 112 stores a set of rules along with a few default rules. The random number generating module 108 uses the default rule for generating the random number when there is no rule mentioned in the configuration database. Further, the default rule stored in the master table 112 is used while the system 100 is used in the random number generation application.

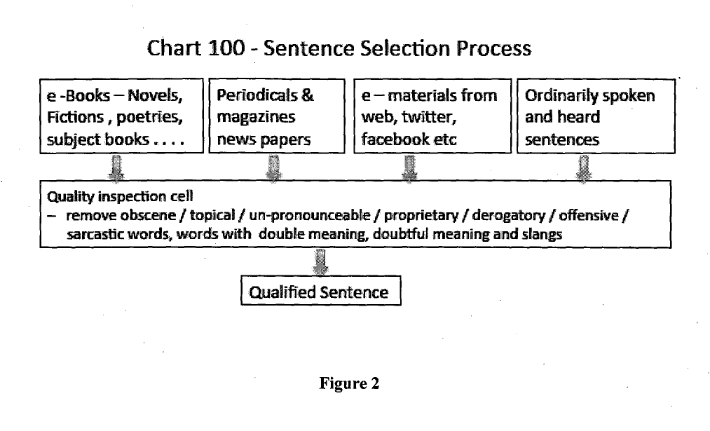

FIG. 2 illustrates a process of sentence selection and sentence processing performed in the sentence selecting module 102 and sentence processing module 106 of the FIG. 1 in accordance to one embodiment herein. The input required for generating random number and/or a product authentication is a sentence which is obtained from the data source 104 through the sentence selecting module 102, in the language generally spoken in the area and which computers can support for entry through keyboard or any other input forms. Thus there is large number of languages such as English, Chinese, German, Hindi, Japanese, Korean etc. in which the input string can be formed. If English as an example language words and sentences such as “paradise”, “is Agatha Christie is a story teller?” are all valid input strings. This makes it easy for someone who knows the language to easily speak the sentence or word and ask the product that caries it as marking to be authenticated. The invention does not require any special type of reader or scanner or device. The sentence can be easily spoken into a phone or sent by traditional post card or mail, or the photocopy of the label or sheet containing the string can be sent to the help centre seeking authentication. This however does not exclude other technologically advanced input methods from being used. For example the smart phone camera, internet, Wi-Fi or phone, texting, web interface with keyboard on the phone are supplementary input methods that can be used if the client decides, but not a precondition for use of this method. This is very much useful in situations such as remote area where specialized input device for product authentication is not possible but exploitation of the community is high as they are most vulnerable. The sentence being not a mixture of numbers or alphanumeric characters with/without special characters is easy to read or repeat. It also makes it possible to pronounce the string easily without error or strain on the memory of the consumer and in a user friendly manner in contrast to the long string of jumble of alphabetic characters of the same size many prior art systems require. Most importantly the selected sentence is checked for not abusive, not sarcastic, not unpronounceable etc.

The plurality of languages and alphabets that are used in the world make it possible to theoretically cover every possible and conceivable number of products at the unit level, yet easily input without any special input device. For example, if let us say the string length is 45 and the language is English it is possible to mark 26 to the power of 45 units uniquely, i.e. 4.71 times 10 to the power 63 units. Since words with as little as 7 letters to sentences running to even 45 or 60 character long can be used for input, there is an unlimited number of units that can be covered by the system yet require no special device to input the sentence used to identify the product.

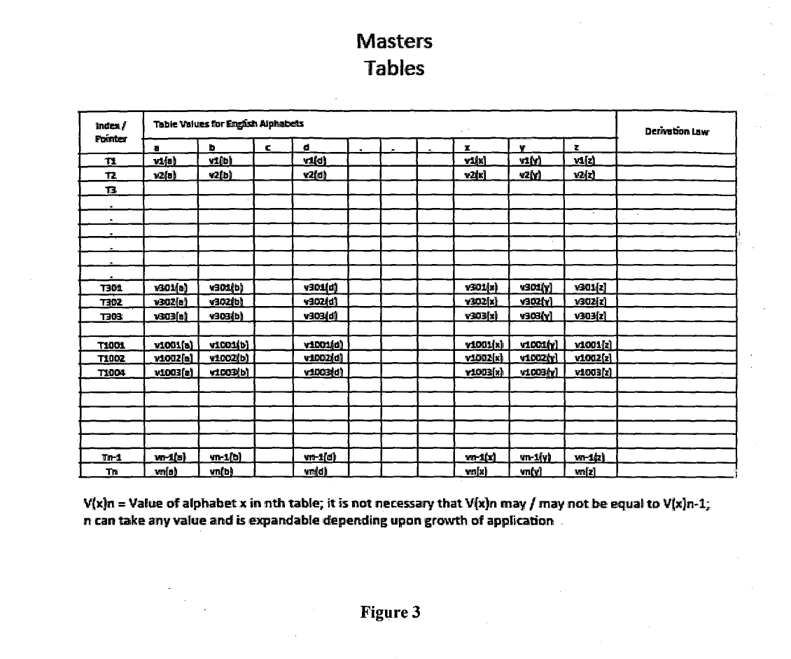

FIG. 3 illustrate the master table 110 of the FIG. 1 in accordance to one embodiment herein. The input i.e. the qualified sentence obtained from the data processing module 106 is then converted into a long “Random number” (i.e. random number) for further manipulations by the random number generating module 108. The random number generating module 108 assigns each alphabet in the qualified sentence to a unique value contained in the master Table 110 with n rows and 2 columns (n*2 table) where n is the number of alphabets in the language with first column listing the alphabet in rows and second column giving the value for each of the said alphabet in the first column in that table. A unique set of values assigned to each alphabet in a language is represented in a “Table”. These tables are put together in a master set called “MASTER TABLE 110”. Thus the master table is a set of tables identified by index numbers such as M1,M2,M3, . . . . and are referred for future use in the application, where M denotes it is part of the master set and 1 indicate that it is the first table in the master. This number, of type Mx, is used as a pointer/index in subsequent other processes or rules setting or parts of the system. This is illustrated in FIG. 3. Take for example the English as the language. There are 26 alphabets and assume that all alphabets are assigned 0 value, then this forms one table. If they are assigned 1 each as value then that is another table. Thus theoretically 26! (referred as 26 factorial equaling the value arrived by 26×25×24×23×3×2×1) unique tables are possible assuming only values from 1 to 26 as the value used for the alphabets. Since any set of integers not necessarily from to 26 and other than this set could be used and also as they need not be a serial numbers, it can be seen that the number of tables can thus be infinite. Hence the Master List of Tables is infinite. Different table of values when used on the same input string would produce different Random number. This results in the plurality of values for the same input string and is a unique feature of the system. The total number of table is infinite as alphabets are taken from sentences of different languages that are infinite.

The “RULES” help to define the starting table that will be used to evaluate the string and convert it into a Random number for that particular application with help of the Pointer obtained from the default value. The Pointer value helps in deducting the index from, which the next value for the iteration is to be computed. The Rules also leads way to handle the next steps of processes.

In this invention the inductiveness is one of the system is its uniqueness. The outputs obtained from the iterations are destroyed each time leaving no space for hacking and ensures trusted system for brand verification and authentication. As per the invention, there is a system for unit level product authentication of plurality of products, including man readable unit level product data. It is novel in using visible commonly used words or sentences with embedded check words and used as markers made available to user in any one of selected language from a number of publicly known languages (assuming there are y known languages) to the general for the authentication. The system essentially has components such as a first storage means having within a Ly Language Table (master table 110). The table shall have ‘n’ rows and two columns. ‘n’ is the number of alphabets and special characters in the language Ly. The first column will list the alphabets and characters in rows. The second column shall contain the value for each of the said alphabet in the first column. The value is a unique value assigned to each alphabet and character of the said language Ly. There is also a second storage means having within a ‘Table Set’ of a language Ly with plurality of language Ly Tables for each specific language wherein all the values assigned to the alphabets and characters of a Table is not exactly the same as the value assigned to each of such alphabets and characters in another Table in the Table set in a manner that unique value of at least some of the alphabets or characters assigned in each Table is different from the assigned value to the said alphabets or characters in another Tables, thereby containing ‘x’ Tables of the language Ly and which ‘x’ Tables collectively form ‘language Ly Table set’ of the language Ly. There is also a third storage means which is a ‘Master Table’ collective of language Ly Table sets with ‘x’ number of Tables of ‘y’ number of languages and wherein each Table is identified with an index. A fourth storage means is Master Rules (Master rules 112) Set with a stored set of designated Rules with plurality of designated Rules consisting of mathematical, non-mathematical, text, logical and computer Rules and formulae, with each Rule being unique in a way that the said Rule is not same as another Rule in the set and identified with an index. A fifth storage means is a Configuration set/database (Configuration database 114) with a stored set of designated Rules specifically selected for a particular product or a brand requiring authentication, partly fixed in nature assigned to the product meant for authentication, and partly out of Master Rules Set from the fourth storage means and a set of Tables from third storage means of Master Table by assigning the specific set of indexes of such Master Tables and Master Rules. A sixth storage means (Book set 116) is configured as table or the database. The table includes ‘n’ rows and ‘m’ columns and wherein each cell in the table includes a cue word. In another embodiment, the book set 116 may be configured as single row and single column with first column containing check-sums and wherein an unique check-word (i.e. cue word) is assigned in the second column to each of the said check-sum.

The system also includes a plurality of reading means for reading from said storage means first to sixth and from the product to be verified. There is a processing means which is operable associated with reading means, plurality of storage means, configuration set, Rules and Tables selectively for the input sentence representative of the product and thereafter to perform the validation request on the product to generate a check-sum.

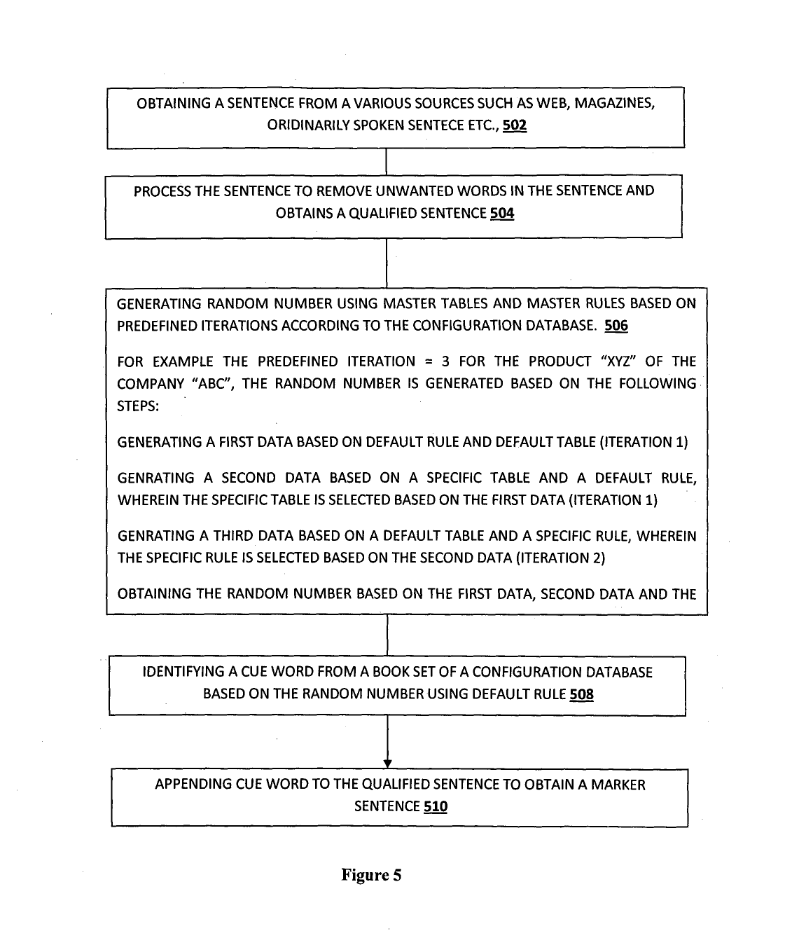

The invention teaches a novel method of product verification. It discloses a method for unit level product verification of plurality of products and plurality of the units and packs of products including man readable product data characterized in using visible commonly used word or sentences with embedded check-word as markers, made available to a user in any one of selected language from a plurality of publicly known languages for the verification comprising of many steps. FIG. 5 is a flow diagram which illustrates a method for generating marker sentence based on the spoken sentence in accordance to one embodiment herein. In astep 502, the sentence is obtained from the data source 102. In astep 504, the sentence is processed to obtain a qualified sentence based on rule stored in the configuration database 114. In astep 506, the random number is generated using the qualified sentence. The random number generation includes the step of assigning a unique value to each alphabet or character of the qualified sentence from the master table 110. The above step is repeated based on the predefined iterations and the rules stored in the configuration database 114. In astep 508, the cue word is identified based on the random number and the rules stored in the configuration database 114. For example, the rule specified in the configuration database 114 is “consider the book set A and Take first two numbers in random number to select the row number in the book set and take last two numbers in random number to select the column number in the book set”. Accordingly, the cue word is obtained from the book set A. In astep 510, the cue word is appended to the qualified sentence based on the rules stored in the configuration database 114.

The below example illustrates a method for generating the marker sentence for the product “A 1” of the manufacturer “XYZ, Inc”.

An example of the configuration database 114 for the above mentioned product is illustrated in TABLE I below. The preferred method for accessing and utilizing this information is described below.

| | |
|---|---|
| Manufacturer | XYZ, Inc |
| Product name | ADCF123 |
| Product code | XYZinc-A14 |
| Iteration | 3 |
| First set of | Remove unwanted words such as articles |
| rules (Criteria) | and stop words and symbols, and the |
| | unwanted words such as sex*, etc., |
| Second set of | Iteration 1: Take the values from the first |
| rules | table of master table for each character and |
| | sum them and divide by 8 to obtain |
| | first data |
| | Iteration 2: Select the table number in the |
| | master table which equal to the first data |
| | Iteration 3: Generate the third data from |
| | the table by taking values from the table |
| | selected in the iteration 2 and append |
| | them |
| Third set of | Use book set A, |
| rules | Take first two numbers in random number |
| | to select the row number in the book set |
| | and take last two numbers in random |
| | number to select the column number in the book set |
| Fourth set of | Cue word attached at the end of sentence |
| rules | |

An example of the master table 110 for the English language of the FIG. 1 is illustrated in TABLE II below.

| M1 | | M2 | | M3 | | . . . . . . . . . . | Mx |
|---|---|---|---|---|---|---|---|
| A | 5 | A | 0 | A | 9 | ooooooooooooooo | |
| C | 8 | B | 5 | Y | 5 | | |
| B | 6 | C | 1 | O | 8 | | |
| G | 9 | D | 2 | G | 7 | | |
| o | | | | | | | |
| o | | | | | | | |
| o | | | | | | | |
| O | 0 | E | 6 | E | 6 | | |
| Y | 7 | G | 7 | D | 2 | | |
| E | 1 | O | 8 | C | 1 | | |
| D | 2 | Y | 9 | B | 0 | | |

An example of the book set A 116 of the FIG. 1 is illustrated in TABLE III below.

| | C1 | C2 | | C85 | | Cm |
|---|---|---|---|---|---|---|
| R1 | | | ooooo | | oooooooooooo | |
| R2 | | | | | | |
| R3 | | | | | | |
| o | | | | | | |
| o | | | | | | |
| o | | | | | | |
| R78 | | | | Gym | | |
| o | | | | | | |
| o | | | | | | |
| o | | | | | | |
| Rn | | | | | | |

For example, the sentence selecting module 102 selects the sentence “the good sexy boy”, the sentence processing module 106 processes the sentence based on the criteria which is mentioned in the table I. Such that the sentence processing module removes the word “sexy” and the article “the”. The random number generating module 108 generates the random number based on the “second set of rules” mentioned in the table I. The random number obtained based on the second set of rule using table II is illustrated below:

Consider the sentence obtained from data source is: The good sexy boy

Qualified sentence: good boy

Random number generation:

(i) 9002607 (Iteration 1)

(ii) 9+0+0+2+6+0+7=24/8=3 (first data); (Iteration 2)

(ii) Select table 3 in master table

(iii) 7882085 (Iteration 3)

The marker generation module 118 identifies the cue word from the book set 118 based on the “third set of rules” mentioned in the table I. The data string obtained from the previous module is 7882085. According to the third set of rules the first two numbers of the random number taken as row number of the book set 116 shown in table III i.e. 78 and the last two numbers of the random number is taken as column number of the book set 116 shown in table III i.e. 85. According the cue word obtained from the table III is “gym”. Further, the marker generation module 118 appends the cue word to the qualified sentence based on the “fourth set of rules” mentioned in the table Ito obtain the final marker sentence as “good boy gym”.

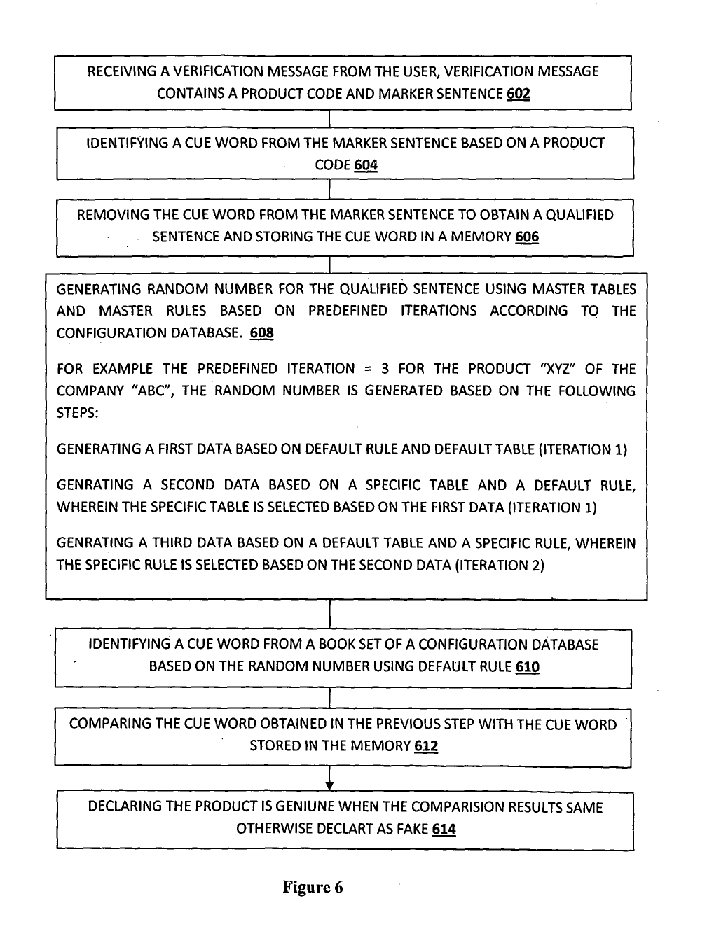

FIG. 6 is a flow diagram which illustrates a method for generating marker sentence based on the spoken sentence in accordance to one embodiment herein. In step 602, the verification message is received from the user. The verification message includes a marker (i.e. marker sentence) and an identifier. The identifier includes but not limited to a product code and a product name. In one embodiment, the identifier can be null. In step 604, the cue word is identified from the marker sentence based on the identifier received in the verification message i.e. the marker verification module identify the cue word based on the set of rules stored in the configuration database which is corresponding to the identifier i.e. the product code and/or the product name. If the verification message does not contain any identifier the verification message applies default rule i.e. which assumes that the last word and/or middle word and/or first word as the cue word. In step 606, the cue word is removed from the marker sentence to obtain the qualified sentence and the cue word is stored temporarily in the marker verification module. In step 608, the random number is generated for the qualified sentence. In step 610, the cue word is identified from the book set of the configuration database. The method for generating the random number and identification of cue word from the book set is explained in detail above. In step 612, the cue word identified in the step 610 is compared with the cue word stored in the step 606. In step 614, the marker verification module sends a declaration message to the user. The declaration message contains the product is genuine when the comparison in step 610 reveals positive result otherwise the declaration message would contain the product fake and/or counterfeit.

The embodiments herein can take the form of an entirely hardware embodiment, an entirely software embodiment or an embodiment including both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system, for the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

Several exemplary embodiments have thus been described. Modifications and alterations may occur to others upon reading and understanding the preceding detailed description. It is intended that the exemplary embodiments be construed as including all such modifications and alterations insofar as they come within the scope of the appended claims or the equivalents thereof.

1. A method for generating a marker which is used for product verification of a plurality of products manufactured by a plurality of manufacturers, said method comprising the steps of:
obtaining (502) a sentence from a data source (104) or from an user;
processing (504) said sentence based on a first set of rules to remove unwanted words in said sentence to obtain a qualified sentence;
generating (506) a random number from said qualified sentence, wherein said random number is generated using master tables and a second set of rules based on a predefined iterations;
identifying (508) a cue word from a book set (116) based on said random number, wherein said random number is processed based on a third set of rules to obtain said cue word from said book set; and
appending (510) said cue word to said qualified sentence as per a fourth set of rules to obtain said marker, wherein said marker is attached to said plurality of products.

2. The method as claimed in claim 1, wherein said first set of rules, said second set of rules, said third set of rules, said fourth set of rules and said predefined iterations are defined in a configuration database (114) for each of said plurality of manufacturers and/or each of said plurality of products.

3. The method as claimed in claim 1, wherein said master table (110) comprises a plurality of tables and each table stores a plurality of characters and its corresponding values.

4. The method as claimed in claim 1, wherein said book set comprises ‘n’ rows and ‘m’ columns and storing a plurality of cue words.

5. The⁻method as claimed in claim 1, wherein said data-source receives a plurality of sentences from variety of sources such as databases or on line.

6. The method as claimed in claim 2, wherein said sentence can be in any commonly spoken or written language and may or may not include specialized languages such as programming languages, current or out of vogue.

7. A method for verifying a marker which is used for product verification of a plurality of products manufactured by a plurality of manufacturer, said method comprising the steps of:
receiving (602) a verification message from a user, wherein said verification message comprises an identifier and a marker;
identifying (604) a first cue word from said marker based on said identifier;
removing (606) said first cue word to obtain a qualified sentence;
storing said first cue word;
generating (608) a random number from said qualified sentence, wherein said random number is generated using master tables and a second set of rules, and said master tables and said second set of rules applied to said qualified sentence for a predefined iterations;
identifying (608) a second cue word from a book set based on said random number wherein said random number is processed based on a third set of rules to obtain said cue word from said book set;
comparing (610) said second cue word and said first cue word; and
communicating (612) to said user that said product is genuine product when said first cue word and said second cue word are same.

8. The method as claimed in claim 7, further comprising:
communicating to said user that said product is counterfeit product when said first cue word and said second cue word are not same.

9. The method as claimed in claim 7, wherein said verification message as a short message service (SMS) message or an electronic mail and wherein said identifier comprises a product code or a product name.

10. A method for generating a text based random number comprising the steps of:
obtaining a sentence from a data source; and
generating a number from said sentence, wherein said number is generated using master tables and a second set of rules, and said master tables and said second set of rules applied to said qualified sentence for a predefined iterations.
said number being obtained from vast source of sentences from multitude of languages and obtained by using tables of values and iterated using rules generated from and out of such sentence, qualifies to be a random number

11. A system for generating a marker which is used for product verification of plurality of products manufactured by a plurality of manufacturer comprising:
a memory which stores
(i) a master table which comprises a plurality of tables and each table stores a plurality of characters and its corresponding values,
(ii) a configuration database which stores a predefined iteration and a plurality of rules corresponds to said plurality of products of said plurality of manufacturer, and
(iii) a book set which stores a plurality of cue words;
a processor (i) configured to receive inputs such as said manufacturer, a sentence, and said product, (ii) manipulates said master table and said book set based on said inputs and said plurality of rules and (iii) obtains said marker.
